(19) United States
(12) Patent Application Publication
(10) Pub. No.: US 2001/0027387 A1
(43) Pub. Date: Oct. 4, 2001

(54) Debugging supporting apparatus, debugging supporting method and recording medium readable by computer with its programs recorded thereon

(76) Inventors: Hideaki Miyake, Hiroshima-ken (JP); Masayoshi Kareki, Hiroshima-ken (JP); Katsumi Tsurumoto, Hiroshima-ken (JP)

Correspondence Address: McDERMOTT, WILL & EMERY, 600 13th Street, N.W., Washington, DC, 20005-3096, US

(21) Appl. No.: 09/812,894

(22) Filed: Mar. 21, 2001

(30) Foreign Application Priority Data
Mar. 30, 2000 (JP) 2000-094064
Dec. 11, 2000 (JP) 2000-375641

(51) Int. Cl. G06F 9/45

(52) U.S. Cl. 703/22

(57) ABSTRACT

Disclosed are a debugging supporting apparatus, a debugging supporting method and its recording medium so constituted that even if an application developed in a simulation environment by OS simulator stops, OS control information can be referred to at that moment.

The debugging supporting apparatus comprises a common file that is shared between the application and the OS debugger and which records common control information including the same data as item forming OS control information, writing means for writing specific item of the OS control information stored in the storage means on the common file as common control information, and reading means for reading out the common control information stored in the common file.

### BACKGROUND OF THE INVENTION

1. Field of the Invention

The present invention relates to a debugging supporting apparatus, a debugging supporting method and a recording medium with its program recorded thereon. More specifically, this invention relates to the debugging supporting apparatus for use in debugging applications developed in a simulation environment by an OS simulator.

2. Description of the Prior Art

In mobile terminals (hereinafter referred to as device) like portable phones, which are fast spreading in recent years, various functions are sought after including telephone call, telephone directory registration and Internet communication. To meet such needs, an application to materialize such functions has come to be embedded in the mobile terminal.

FIG. 7 illustrates a development environment for an application of the embedded type. FIG. 7(a) is a conceptual diagram showing the state in which an application is embedded in the device. Application 210 usually operates on an operating system exclusively for devices (hereinafter referred to as dedicated OS 220a). In accordance with a request from application 210, the dedicated OS 220a controls hardware within the device whereby various functions are materialized on the device.

Therefore, development of application 210 of such an embedded type has to be carried out along with development of hardware of the device or dedicated OS 220a. The application 210 is generally developed in a general-purpose computer in which a virtual environment (hereinafter referred to as simulation environment) simulating the environment of the device, that is, the embedding destination of application 210, is built on a general-purpose OS.

FIG. 7(b) illustrates the state of a simulation environment on a general-purpose computer. Application 210, OS simulator 220, application debugger 230 and OS debugger 240 are executed on the general-purpose OS 250 that controls the hardware within the general-purpose computer. In FIG. 7(b), the OS simulator 220 to virtually execute the operation of the dedicated OS 220a (for example, task control operation, resource control operation of event flag etc.) is linked to application 210 in the form of library. That builds a simulation environment for the device in which the application 210 is embedded.

FIG. 7(b) illustrates the state of the simulation environment on the general-purpose computer. On the general-purpose OS 250 to control the hardware within the general-purpose computer, the application 210, OS simulator 220, application debugger 230, OS debugger 240 are executed. In FIG. 7(b), the OS simulator 220 that virtually carries out the operation of the dedicated OS 220a (for example, task control operation, resource control operation like event flag) is executed. In other words, this OS simulator 220 builds a simulation environment for the device in which application 210 is embedded.

In this connection, the OS simulator 220 is linked to the application 210 in the form of library, and when the application 210 is executed, the OS simulator 220 operates as if the OS simulator 220 is executed. The reasons why the OS simulator is mounted in the form of library are those. That is, the user who does debugging can utilize the function of the OS simulator by just linking only one library offered by OS simulator. It is not necessary for the OS simulator 220 to simulate the dedicated OS 220a to the full extent. Only the part required for development should be simulated. And it is easy to adapt to changes in specifications of the hardware in which the application is intrinsically embedded. Provision of only the part required for development and that in the form of library makes it easy to materialize the function of the OS simulator and also to change this function.

Therefore, the actual simulation environment on the general-purpose computer is so made that, as shown in FIG. 8, application 210 operates on the general-purpose OS 250 and, within the application 210, the OS simulator 220 operates simulatively.

Now, the debugging of the application 210 is performed using application debugger 230 containing a development tool for general-purpose application (not shown). The expression “debugging” as used herein means the process of removing a bug in a program, while the expression “debugger” as used herein means a utility program which enables debugging to be performed efficiently.

In debugging the application 210, it can happen that the user who instructs debugging refers to or change various kinds of information (hereinafter referred to as OS control information) that the OS simulator 220 controls in a memory (not shown). Among the OS control information is an event flag which indicates by a bit pattern of 1 or 0 the state of task in executing application 210 or the presence or absence of an event to change the state of task.

It can be said that to grasp (refer to) the state of the dedicated OS and to change the state is a very effective means in debugging the application 210.

However, application debugger 230 is a tool for development of a general-purpose application and therefore is not provided with such a function as to refer to or change OS control information. In recent years, debugging support systems have been disclosed that are provided with an OS debugger 240, a utility program to control OS control information in addition to the application debugger 230.

FIG. 6 is a functional block diagram showing an example of conventional debugging supporting systems. As shown in FIG. 6, OS debugger 240 is in a process space separated from that for OS simulator 220.

Therefore, the OS debugger 240 can not refer to a memory area (storage means) which is allocated for the application 210 and where the OS control information is stored. Furthermore, because such information as where in the memory means and what information is stored is controlled by the OS simulator 220, the OS debugger 240 can not understand the contents even if it can physically refer to the OS control information.

Therefore, communication means C1, C2 are provided on both the application 210 side and the OS debugger 240 side which enables to control the OS control information controlled by the OS simulator from the OS debugger 240 side by communication means C1, C2 maintaining inter-process communication via the general-purpose OS.

In addition, it can happen that to make it easy to aim at the position of a bug in debugging, the application 210 is stopped as by setting a break point so that the OS control information at that moment can be referred to.

However, if the application 210 stops, the OS simulator 220 linked to the application 210 also stops. That is because, as mentioned above, the OS simulator 220 is linked to the application and operates as OS simulator simulatively.

In an arrangement in which inter-process communication is adopted like the conventional debugging supporting system as shown in FIG. 6, if the application 210 stops, it will be impossible to keep up communication between the OS simulator 220 and the OS debugger 240. For this reason, the OS debugger 240 can not refer to (acquire) OS control information through communication at the moment when the application 210 stops. That is, the user finds it difficult to find a bug in debugging.

Such a problem presented by inter-process communication does not come to the front in particular generally when a application is used on the general-purpose OS. That is because normal operation is guaranteed to ordinary applications to some extent.

In developing an application, however, it is routine work that a break point is set to the application to stop the application. Furthermore, an application under development does not operate perfectly. That is, the circumstances are special in that the hang-up of the application is daily happenings.

In such a situation, acquisition of OS control information by the inter-process communication is often useless. Furthermore, that the OS control information can not be referred to reduces the debugging efficiency, resulting in delay in application development.

### SUMMARY OF THE INVENTION

Accordingly, it is an object of the present invention to provide arrangements that even if an application developed in a simulation environment by OS simulator stops, OS control information at that moment can be referred to without fail and to raise the debugging efficiency of the application.

To effect the object of the present invention, the following means are adopted. That is, the present invention is built on a debugging supporting apparatus provided with an application to which is linked an OS simulator to simulate a specific OS on the general-purpose OS, storage means for storing OS control information controlling the application under the control of the OS simulator and an OS debugger to refer to or change OS control information. Here, a common file is shared by the application and the OS debugger and at the same time stores the shared control information including the same data as item constituting the OS control information. In addition, writing means writes in the common file specific item of the OS control information stored by the storage means. Reading means reads out common control information stored in the common file.

Under such arrangements, a change in OS control information is reflected in the common control information of the common file, and therefore even if the application stops, the OS debugger can readily refer to the same information as OS control information. That makes debugging efficient.

Furthermore, since the OS simulator is materialized by a technique providing an OS simulator as library, it is possible to easily materialize efficient debugging and OS simulator function. And it is also possible to change the function without difficulty.

Furthermore, it is so arranged that there are provided application communication means and OS debugger communication means. In case writing means writes in the common file a change in the specific item as the common control information, application communication means sends instructions to read the common control information from the application to the OS debugger, and OS debugger communication means issues to the reading means instructions to read the common control information.

In addition to the above, the application communication means sends to the OS debugger directions to read the common control information and at the same time stops execution of the application. The OS debugger communication means sends back to the application directions to free the stop of the application after reading out the common control information.

In those arrangements, the OS debugger acquires all changes in OS control information without exception, and can share data without fail while synchronizing with the application though the OS debugger is in a space separated from that for the application.

Furthermore, it can be so arranged that the common file is shared between the application and the OS debugger and at the same time stores the common control information including debugging instructions to change OS control information stored in the storage means. In addition, debugging instructions writing means writes the debugging instructions in the common file as the common control information and at the same time debugging instructions reading means reads out debugging instructions from the common control information stored in the common file, while OS control information changing means changes specific item making up the OS control information according to instructions read out by debugging instructions reading means.

Under the above arrangements, even if OS control information indicates a false value as, for example, because of the presence of a bug in the application, this OS control information can be changed from the OS debugger. Also, if such a changing function is utilized, it is also possible to create a situation where an interruption occurs without modifying the program of the application.

### BRIEF DESCRIPTION OF THE DRAWINGS

Having summarized the invention, a detailed description of the invention follows with reference being made to the accompanying drawings which form part of the specification, of which:

FIG. 1 is a functional block diagram of a debugging supporting apparatus in a first embodiment of the present invention.

FIG. 2 is a functional block diagram of a debugging supporting apparatus in a second embodiment of the present invention.

FIG. 3 is a functional block diagram of a debugging supporting apparatus in a third embodiment of the present invention.

FIG. 4 is a flow chart showing the flow of the respective means of the debugging supporting system of the same embodiment.

FIG. 5 is an example of the screen on which the state transition of a plurality of tasks in the same embodiment is displayed.

FIG. 6 is a schematic functional diagram of the prior art debugging supporting system.

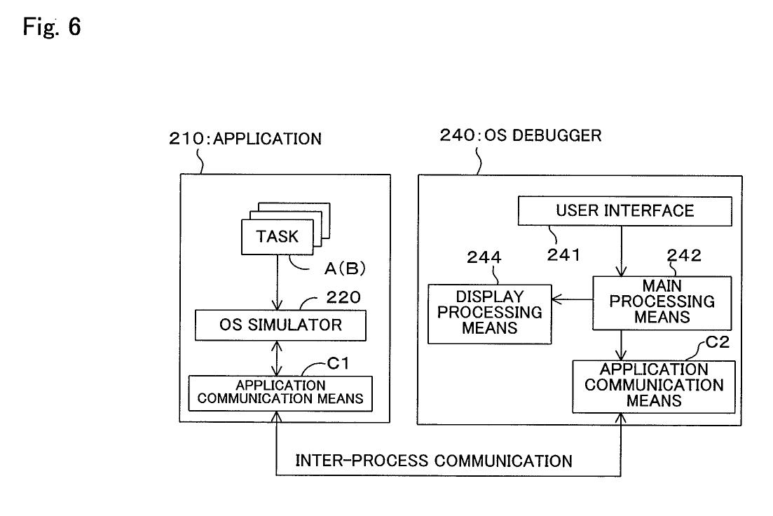

FIG. 7 is a conceptual diagram of an application environment of the embedded type.

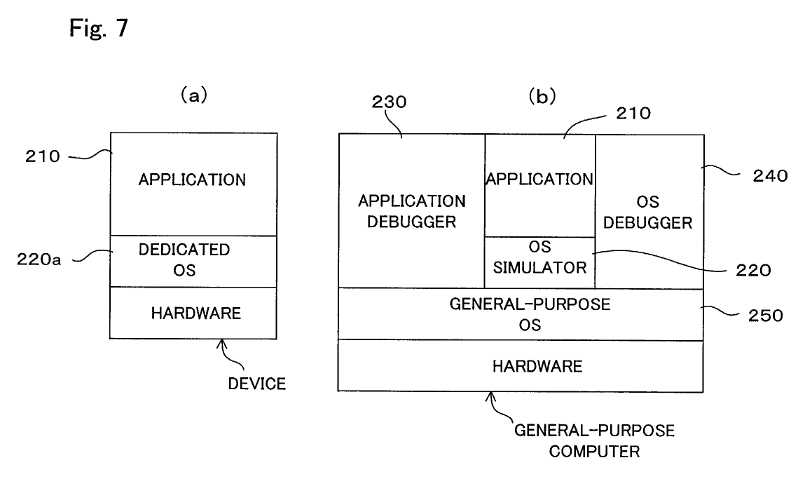

FIG. 8 shows a linking state in the application environment of the embedded type.

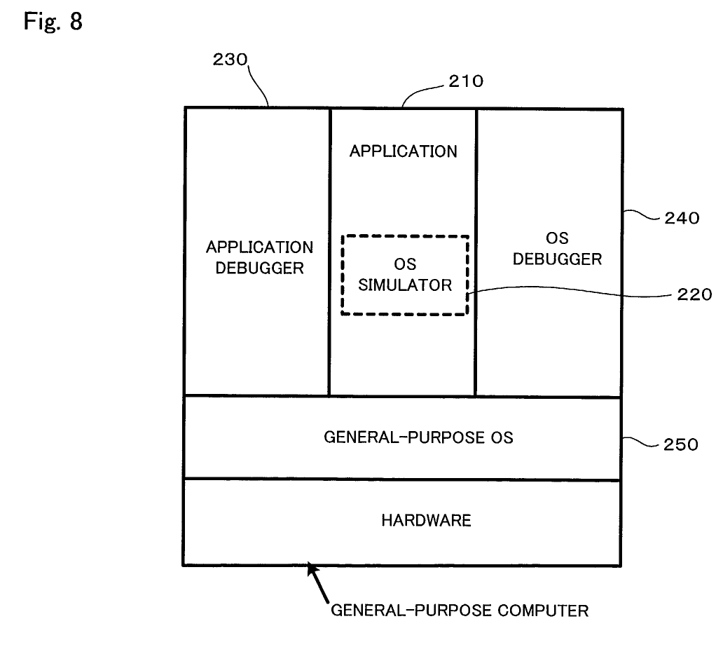

### DESCRIPTION OF THE PREFERRED EMBODIMENTS

Embodiment 1

Now, the first embodiment in the debugging supporting system of the present invention will be described in detail with reference to the drawings. In the present embodiment, there will be explained about an example where the debugging supporting system of the present invention is applied to debugging of an application for mobile terminals such as portable phones.

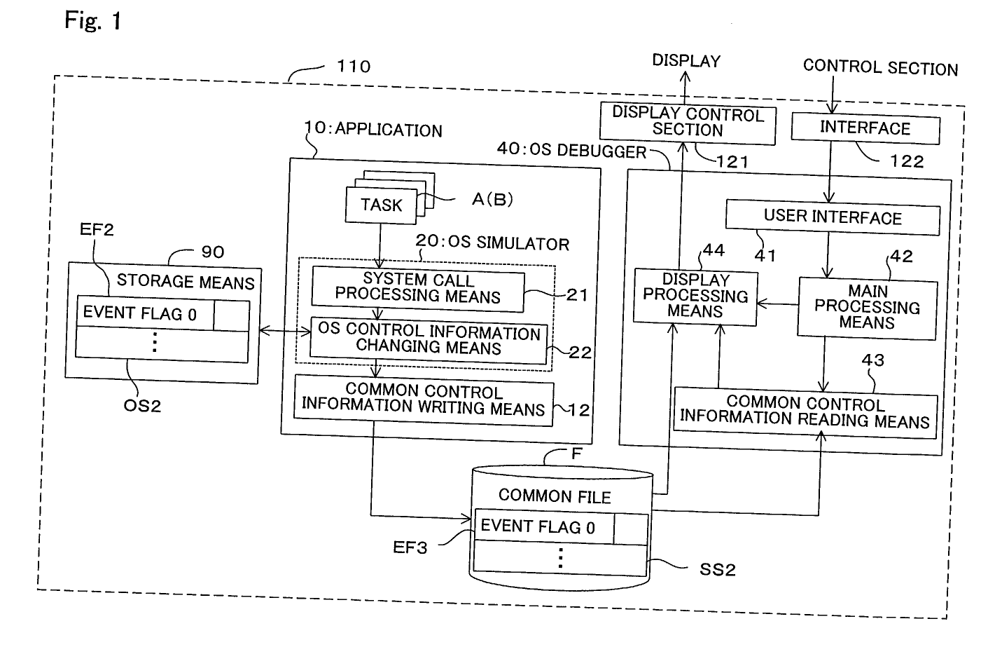

FIG. 1 is a functional block diagram of a debugging supporting apparatus to which the present invention is applied. The debugging supporting system 110 according to the present embodiment is provided with application 10, OS simulator 20, storage means 90, OS debugger 40, common file F, display control section 121, interface section 122 and an application debugger (not shown). In this debugging supporting system 110, the general-purpose OS (not shown), OS simulator 20 and OS debugger 40 cooperate to build a simulation environment of the machine that the application 10 is embedded.

The application 10 is a program that performs various operations of the mobile terminal. To the application 10, the OS simulator 20 is linked in the form of library and furthermore is provided with common control information writing means 12 (writing means).

The OS simulator 20 is provided with system call processing means 21 and OS control information changing means 22, and simulatively executes operations (functions) of dedicated OS (not shown) such as task control or resource control of event flag.

The system call processing means 21 processes a system call issued by a task when the task of the application 10 is executed by an application debugger (not shown) and, in addition, informs OS control information changing means 22 of instructions to change OS control information that occurs in processing the system call. The expression “OS control information” as used herein is data controlled by OS simulator. They include an event flag indicating by a bit pattern of 1 or 0 the state of a task being executed by the application 10 or the presence or absence of an event to change the state of task.

The OS control information changing means 22 changes the OS control information OS2 stored in storage means 90 which will be described later according to instructions to change OS control information from system call processing means 21 and informs common control information writing means 12 of contents of changes in OS control information OS2.

The common control information writing means 12 writes the contents of change—in OS control information OS2 given by OS control information changing means 22—on the common file F which will be described later.

Storage means 90 is formed of RAM (random access memory). In storage means 90, OS control information OS2 is stored which is changed by OS control information changing means 22. In FIG. 1, OS control information as an example is stored which corresponds to task A of the application 10. OS control information OS2 contains event flag EF2. The event flag EF2 is a flag indicating by a bit pattern of 1 or 0 the presence or absence of an event to change the state of task A.

Here, it is conceivable that the OS simulator simulates real-time OS, for example. In the case of real-time OS, a response generally has to be returned within the time set for a specific interruption. For this reason, there is no possibility in practice that a storage medium of slow access like the common file provided on hard disk etc. is used. That is, in case the OS simulator simulates the real-time OS, a medium accessible at a high speed like RAM is used in storage means 90 as a matter of course.

The common file F is stored in a hard disk shared by application 10 and OS debugger 40, and shows a group of data including the common control information SS2 shared in the respective processes that is executed on general-purpose OS. The common file F stores common control information SS2 including the same data as OS control information stored in the storage means 90, that is, item constituting OS control information. The common control information may either store all item or part of the item contained in OS control information.

It is so arranged here that changes in OS control information OS2 are reflected on common control information SS2 of the common file F synchronizing with changes of OS control information OS2 by OS simulator 20 along with execution of application 10 per task. That materializes the sharing of OS control information OS2 via the common file F in the respective processes of application 10 and OS debugger 40. Furthermore, because common control information SS2 is shared between application 10 and OS debugger 40, it is desirable to store a non-volatile memory like hard disk. The memory may be outside recording medium like FD. That is because the sharing between application 10 and OS debugger 40 is ensured with no possibility of common control information SS2 being erased.

In FIG. 1, common control information SS2 is stored as an example which includes item constituting OS control information corresponding to task A. The common control information SS2 contains an event flag EF3. The event flag EF3 corresponds to the event flag EF2 on storage means 90. That is, it is so arranged that OS control information OS2 of storage means 90 and common control information SS1 are completely synchronized.

OS debugger 40, a utility program to operate OS control information OS2, is provided with user interface 41, main processing means 42, common control information reading means 43 (reading means), display processing means 44.

The common control information reading means 43 reads out common control information SS2 on instructions of main processing means 42 and sends the read common control information SS2 to display processing means 44. Through the display control section 121, the display processing means 44 converts into image signals the common control information SS2 read out by common control information reading means 43 and displays the same on the display screen (not shown).

If informed by the user of the input signal from an operation panel (not shown) via the interface section 122, user interface 41 instructs main processing means 42 to do processing to display common control information SS2 stored in common file F1. Main processing means 42 instructs common control information reading means 43 to read common control information SS2 on instructions from user interface 41.

Then, in the present embodiment, a control section (not shown) including the central processing unit (CPU) performs control in cooperation with the respective circuits other than CPU according to the program of the present invention. For purpose of simplicity, however, control actions involving CPU will be explained on the assumption that a program like application 10 directly controls the control actions.

Now, an example will be explained in which task A is executed and system calls “set_flg,” “clr_flg” are issued. By the system call, an arbitrary bit can be set to put another task in a waiting state or free from a waiting state to be put in an execution state. If a system call “set_flg” is issued, the value of the event flag EF2 of OS control information OS2 is changed from 0 to 1. If a system call “clr_flg” is issued, the value of event flag EF2 of OS control information OS2 is changed from 1 to 0.

The process flow on the application 10 side will be explained. By application debugger (not shown), task A of application 10 is executed and system call “set_flg” is issued. The issued system call “set_flg” is processed by system call processing means 21, and OS control information changing means 22 is informed by system call processing means 21 of instructions to change the value of event flag EF2 of OS control information OS2 from 0 to 1.

Then, so informed, OS control information changing means 22 changes the value of event flag EF2 from 0 to 1 and informs common control information writing means 12 that event flag EF2 is changed from 0 to 1.

Common control information writing means 12 writes the contents of change of OS control information OS2 in event flag EF3 of the common file F. To be concrete, the value of the common control information SS2 of event flag EF3 is changed from 0 to 1.

Next, let it be supposed that after the contents of change of OS control information OS2 are written in the common file F, the operation of application 10 is stopped. Then in case the user wants to see the state of the event flag at the moment when the operation of application 10 is stopped, the user operates the operation panel such as a keyboard, and the signal inputted is notified to the user interface 41 through the interface section 122. According to directions from user interface 41, main processing means 42 instructs common control information reading means 43 to read event flag EF3 of the common control information SS2.

Common control information reading means 43 reads event flag EF3 of the common control information SS2 on instructions of main processing means 42. Information event flag EF3 read out is notified from common control information reading means 43 to display processing means 44, and converted into an image signal at the display control section 121 to be displayed on a display screen (not shown).

The image signal is so displayed that the user can visually understand that event flag EF3 is 1, and the user easily can know the processing linkage between application 10 and general-purpose OS, and also know that synchronizing is effected between application 10 and OS debugger 40 in processing.

As set forth above, synchronized with the change of OS control information OS2 by OS control information changing means 22, the change of OS control information OS2 is reflected on the common control information SS2 of the common file F. Therefore, even if application 10 stops, OS debugger can readily refer to OS common control information SS2. That makes debugging efficient.

It is also noted that since the OS simulator is provided as library, it is possible to effect efficient debugging and at the same time the function of an OS simulator and to change this function without difficulty.

The time when the value of the event flag is read out from the common file F is not restricted to the time when a “refer to the event flag” direction is issued. For example, it may be so configured that common control information reading means 43 is provided with means for directing the common control information SS2 including event flag EF3 to be read out cyclically. By this, it is possible to know the time-wise transition of OS control information OS2. Therefore, it is possible to discover unexpected, irregular states of execution of application 10 without difficulty and, in addition, to improve the efficiency of debugging.

An example where system call “set_flg” is used has been explained. In case system call “clr_flg” is used, too, it is possible to let the use visually know that event flag EF2 of OS control information OS1 is changed from 1 to 0.

Furthermore, if the memory areas within the common file F are allocated in advance by types of data contained in OS control information OS2, needless to say, not only event flag but also other OS control information (task state, semaphore state, mail box state etc.) can be referred to in the same manner.

Embodiment 2

The second embodiment of the debugging supporting apparatus of the present invention will be described in detail with reference to the drawings. In the present embodiment, in case the value of OS control information OS2 referred to on the display screen is false in the first embodiment, OS control information OS2 can be changed from the OS debugger 40 side.

In case an OS control information OS2 having a false value occurs in debugging, a bug is present in application 10 and the debug has to be verified and removed.

To improve the efficiency of debugging, however, verification is not carried out each time a bug occurs, but the operation of application 10 is verified as a whole. In the debugging supporting apparatus 120, in case the value of OS control information referred to on the display screen is false, data containing the false value in OS control information OS2 can be changed from the OS debugger side. Thus, operation of application 10 can be continued without correcting the program of application 10. And the efficiency of debugging can be improved.

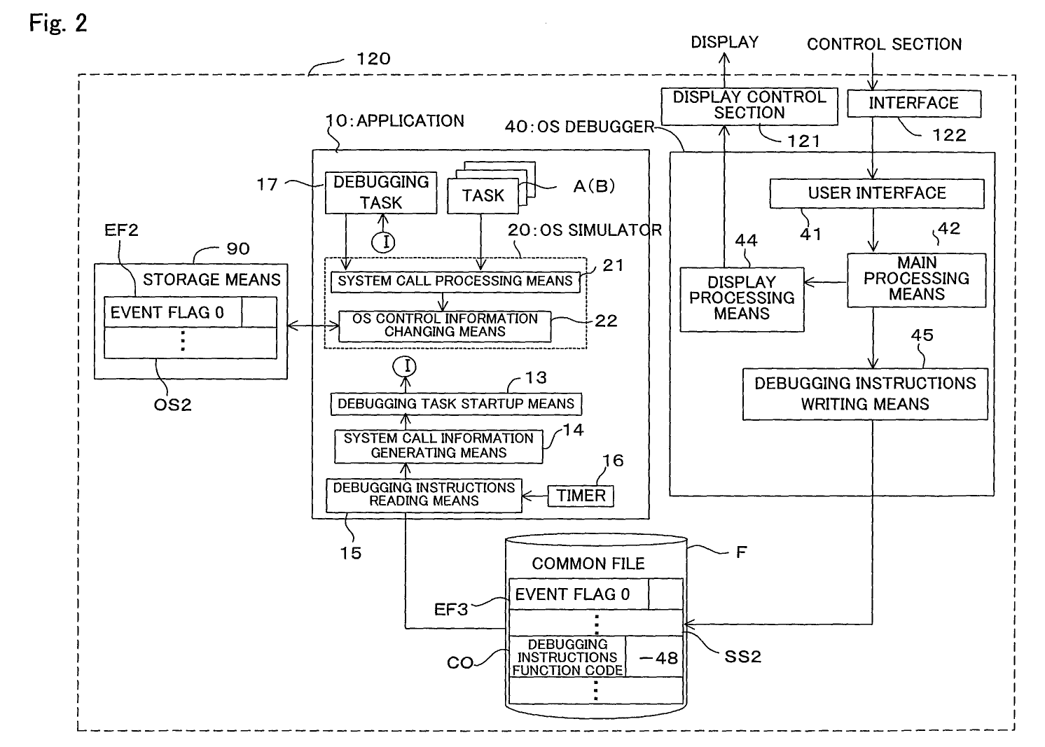

FIG. 2 is a functional block diagram of the debugging supporting apparatus in the present embodiment of the present invention. Like debugging supporting apparatus 110 in the first embodiment, the debugging supporting apparatus 120 in the present embodiment is provided with application 10, OS simulator 20, storage means 90, OS debugger 40, the common file F, display control section 121, interface section 122 and an application debugger (not shown). As the debugging supporting apparatus 110 in the first embodiment, the debugging supporting apparatus 120 has, though not shown, common control information writing means 12 (not shown) on the application 10 side and common control information reading means 43 on the OS debugger 40 side and can read and write data in the common file F. There will now be explained about differences in arrangement between the debugging supporting apparatus 120 in the present embodiment and the debugging supporting apparatus 110 in the first embodiment.

First, in the present embodiment, application 10 is provided with debugging task startup means 13, system call information generating means 14, debugging instructions reading means 15 and timer 16 in addition to OS simulator 20.

Debugging instructions reading means 15 reads debugging instructions codes contained in common control information SS2 of the common file F cyclically using timer 16. The expression debugging instructions functional code used herein means data to specify a system call to change data of OS control information OS2 by OS simulator 20.

System call information generating means 14 generates information (hereinafter referred to as system call information) to specify the execution task of a system call corresponding to the debugging instructions functional code. The debugging task startup means 13 starts up debugging task 17 in accordance with the system call information generated by system call information generating means 14. The started debugging task 17 is executed by OS simulator 20, and OS control information OS2 of storage means 90 is changed.

The OS debugger 40 is provided with debugging instructions writing means 45 in addition to user interface 41, main processing means 42 and display processing means 44.

The debugging instructions writing means 45 writes in the common file F the debugging instructions functional code corresponding to debugging instructions in compliance with the user's direction to correct OS control information OS2 (hereinafter debugging instruction).

There will be explained the process flow from OS debugger 40 to the step in which OS control information OS2 is finally changed. Described here is an example where after system call “set_flg” is executed by task A as described in Embodiment 1, the event flag EF3 of the common file F is “0.” In this case, the event flag EF2 of OS control information OS2 has to be finally changed to “1.”

The process flow from the OS debugger side will be explained. In case the user finds that the event flag EF3 indicates a false value “0,” debugging instructions is inputted from the operation panel to change event flag EF2 of OS control information OS2 to “1.” The inputted debugging instructions are given to the user interface 41 of OS debugger 40 through the interface section 122. Then, in compliance with directions from user interface 41, main processing means 42 instructs debugging instructions writing means 45 to write in common control information SS2 the debugging instructions functional code (−48) to specify system call “set_flg.” So instructed, the debugging instructions writing means 45 writes the debugging instructions functional code CO in common control information SS2 in accordance with instructions from main processing means 42.

That way, debugging instructions inputted from the operation panel by the user is written in the common file F.

Next, the process on the application 10 side will be explained. First, debugging instructions functional code CO is read out by debugging instructions reading means 15 and referred to system call information generating means 14. Here, debugging instructions reading means 15 reads the debugging instructions functional code in the common file F cyclically using a timer. It is desirable that the reading cycle is shorter than the cycle in which debugging instructions functional codes are written. That ensures that all the debugging instructions functional codes will be read out without fail.

System call information generating means 14, which receives the debugging instructions functional code, generates system call information such as, for example, a parameter and hands over the same to debugging task startup means 13. Then, according to the system call information, debugging task startup means 13 starts up debugging task 17 to issue a system call “set_flg.”

The system call “set_flg” is issued to OS simulator 20 by the started up debugging task 17, and event flag EF2 of OS control information OS2 is changed from “0” to “1.” After the event flag EF2 is changed, task B in the state of waiting for event flag EF2 is put in the execution state.

As set forth above, even if OS control information OS2 indicates a false value because of the presence of a bug, this OS control information OS2 can be changed from OS debugger 40 in the present embodiment. Furthermore, if this changing function is utilized, it is possible to create a situation where an interruption occurs without correcting the program of application 10.

The way to specify system call information is not limited to the parameter to specify a system call “set_flg” but may be delivery of a message to specify a system call “set_flg.” Also, it is all right if system call information is specified using the common file F. To be specific, it may be so configured that debugging task 17 refers directly to the debugging instructions functional code in the common file F and generates system call information.

It is so arranged that debugging instructions are directed from OS debugger 40, but the present invention is not limited thereto. In other words, it may be so arranged that with a debugging instruction stored in the common file F in advance, this debugging instruction is read out cyclically (or at any time) by debugging instructions reading means 15. This way, OS control information OS2 can be changed without using OS debugger 40.

Means for execution of debugging instructions is not limited to debugging task 17. In the example shown here, debugging instructions are executed as debugging task 17 issues a system call. But since there are different kinds of system call—the first kind that can be issued from task only, the second kind that can be issued from the interruption handler, and the third kind that can be issued from both, execution means is selected according to the kind of system call.

In the above example, furthermore, the state transition of debugging task 17 is not mentioned in particular, but debugging task 17 that has finished issuing a system call may either disappear or remain (in the state of waiting for the next debugging instruction to be written in the common file F).

Embodiment 3

A third embodiment in the debugging supporting apparatus of the present invention will be described in detail with reference to the drawings.

The debugging supporting apparatus in the present embodiment is provided with a common file like those in other embodiments, and, in addition, communication means for execution of inter-process communication between the application and OS debugger. By this communication means, OS debugger can refer to all the contents of change in OS control information without exception when OS control information is changed by the OS simulator. To be concrete, in case data is read out cyclically from the common file by OS debugger using a timer, the cycle in which data is read out from the common file by OS debugger using a timer can be synchronized with the cycle in which OS control information is changed by OS simulator.

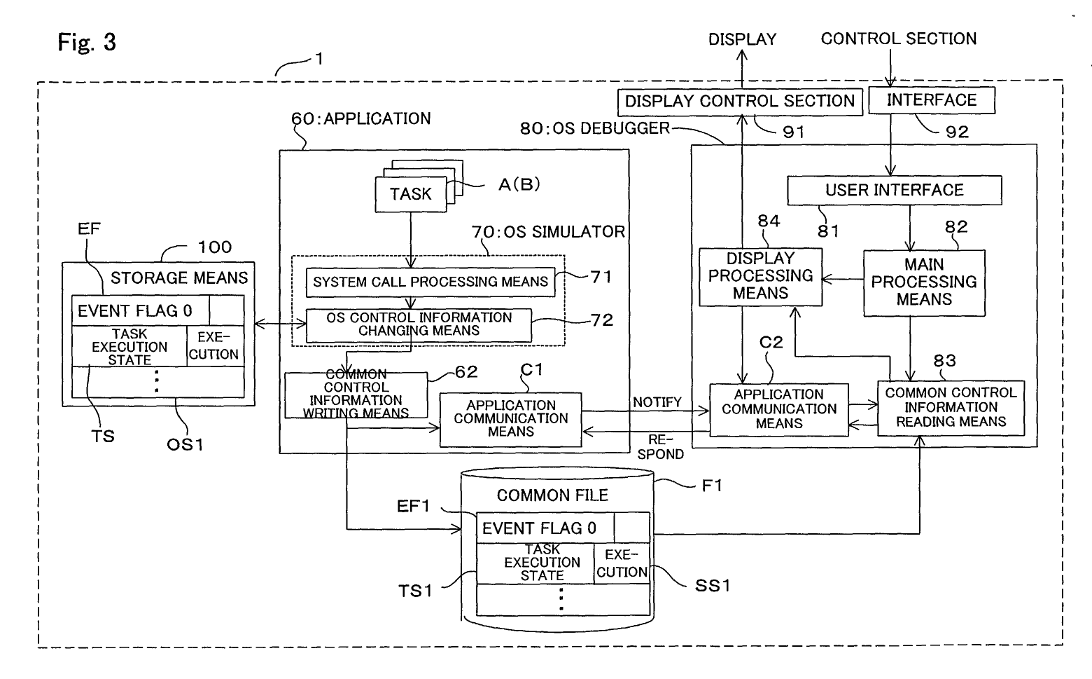

FIG. 3 is a functional block diagram of the debugging supporting apparatus in the present embodiment. The debugging supporting apparatus 1 in the present embodiment is provided with application 60, OS simulator 70, storage means 100, OS debugger 80, common file F, display control section 91, interface section 92 and an application debugger (not shown) for example. In the debugging supporting apparatus 1, general-purpose OS (not shown), OS simulator 70 and OS debugger 80 cooperate to create a device simulation environment where application 60 is embedded.

The application 60 is different kinds of programs to be executed in mobile terminals. The application 60 to which OS simulator 70 is linked in the form of library is provided with common control information writing means 62 and application communication means C1.

The OS simulator 70 is provided with system call processing means 71 and OS control information changing means 72, and carries out simulatively the operation of dedicated OS (not shown) like task control and resource control such as event flag.

The system call processing means 71 processes a system call issued when a task of application 60 is executed by application debugger (not shown) and notifies to OS control information changing means 72 instructions to change OS control information by processing the system call. OS control information is data controlled by OS simulator. The examples include an event flag indicating by a bit pattern 1 or 0 the execution situation showing the state of task being performed by application 60 and the presence or absence of an event to change the task state.

The OS control information changing means 72 changes OS control information OS1 stored in storage means 100—which will be described later—according to instructions to change OS control information from system call processing means 71, and notifies common control information writing means 62 of contents of change of OS control information OS1.

The common control information writing means 62 writes the contents of change of OS control information OS1—given by OS control information changing means 72—in common file F1 which will be described later.

The application communication means C1 conducts inter-process communication between application 60 and OS debugger 80. That is, application 60 informs OS debugger 80 through the application communication means C1 to the effect that the contents of change of OS control information OS1 are written in the common file F1 by common control information writing means 62.

The storage means 100, which is formed of RAM (random access memory), stores OS control information OS1 changed by OS control information changing means 72. In FIG. 3, OS control information corresponding to task C of application 60 is stored as an example. OS control information OS1 includes event flag EF and task execution state TS. The event flag EF indicates by a bit pattern of 1 or 0 the presence or absence of an event that changes the state of task C. And task execution state TS is the state of task C being executed by application 60. In the example shown in FIG. 3, task C is being executed.

The common file F1 is shared by application 60 and OS debugger 80 as the common file F shown in the other embodiments. In the common file F1, common control information SS1 is stored which includes item constituting OS control information stored in storage means 100. In FIG. 3, common control information SS1 is stored as an example which includes the same data as OS control information corresponding to task C of application 60. The common control information SS1 includes event flag EF1 and task execution state TS1. Event flag EF1 corresponds to event flag EF of storage means and task execution state TS1 corresponds to task execution state TS of storage means.

Furthermore, it is so arranged that in common control information SS1 in the common file F1, synchronized with the changes of OS control information OS1 by OS simulator 70 as each task is executed by application 60, changes of OS control information OS1 are reflected. In addition, in case OS debugger 80 receives a notice of change from application communication means C1, common control information SS1 in which the change in OS control information OS1 is reflected is read out by OS debugger 80. That is, OS control information OS1 in storage means 100 is completely synchronized with common control information SS1 of the common file F1.

On top of that, OS debugger 80, a utility program, is provided with user interface 81, main processing means 82, common control information reading means 83, display processing means 84 and OS debugger communication means C2.

The OS debugger communication means C2 conducts inter-process communication with application 60. That is, in case word is received from application communication means C1 that the contents of change are written in common control information SS1 of the common file F1, instructions to read common control information SS1 is issued to common control information reading means 83.

The common control information reading means 83 reads out common control information SS1 according to instructions by OS debugger communication means C2, and instructs display processing means 84 to display the read out common control information SS1. The display processing means 84 converts common control information SS1 read out by common control information reading means 83 into image signals at display control section 91 and displays the signals on a display screen (not shown).

The user interface 81 instructs main processing means 82 to do processing to display common control information SS1 stored in the common file F1 when a signal inputted from the operation panel (not shown) by the user is given through the interface section 92. The main processing means 82 instructs common control information reading means 83 to read out common control information SS1 on instructions from user interface 81.

The present embodiment includes a control section including the central processing unit (CPU) materializes control actions that are executed in cooperation with the respective circuits other than CPU according to the program of the present invention. But for sake of simplicity, the present embodiment will be described on the assumption that programs such as application 60 directly control actions.

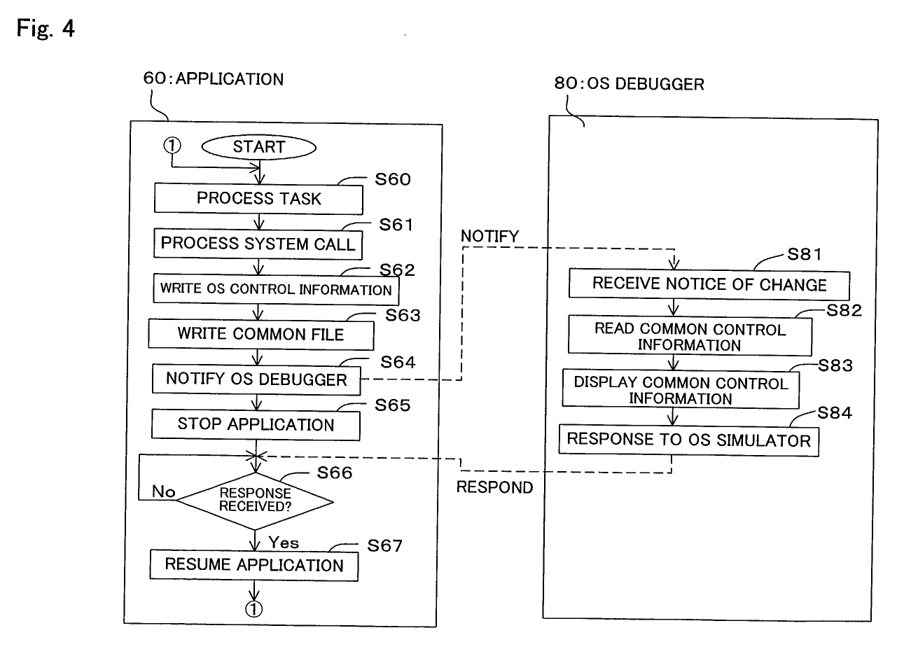

Now, the flow of concrete processes by application 60, OS simulator 70 and the respective means provided in OS debugger 80 will be described with reference to a drawing. FIG. 4 is a flow chart showing the flow of processes by the respective means of the debugging supporting apparatus 1.

There will be explained a case where task C is executed and system call “set_flg” is issued by way of example. By the way, with an arbitrary bit set on the event flag, other tasks can be put in a waiting state or put out of a waiting state and put in an executable state. Furthermore, it is so configured that if system call “set_flg” is issued, the value of event flag EF of OS control information OS1 is changed from 0 to 1. If system call “clr_flg” is issued, the value of event flag EF of OS control information OS1 is changed from 1 to 0.

First, the process flow on the application 60 side will be explained. Task C of application 60 is executed by application debugger (not shown), and system call “set_flg” is issued (Step S 60). Then, the issued system call “set flg” is processed by system call processing means 71 (Step S 61), and instructions to change the value of event flag EF of OS control information OS1 from 0 to 1 are given to OS control information changing means 72.

Then, OS control information changing means 72 changes the value of event flag EF of OS control information OS1 from 0 to 1 (Step S 62). And common control information writing means 62 is informed that event flag EF is changed from 0 to 1.

The common control information writing means 62 writes the contents of change of OS control information OS1 in event flag EF1 of the common file F1 (Step S 63). To be concrete, the value of event flag EF1 of common control information SS1 is changed from 0 to 1.

If event flag EF1 of common control information SS1 is changed, application communication means C1 sends to OS debugger communication means C2 instructions (hereinafter notice of change) to read out the changed common control information SS1 of common control information SS1 (Step S 64). Then, the operation of application 60 is stopped by application communication means C2 (Step S 65). As an alternative to that, the notice of change from application communication means C1 to OS debugger communication means C2 may be served via flag on RAM showing that common control information SS1 is changed or the communication function of OS may be utilized.

On the application 60 side, while the execution of application 60 is suspended, application communication means C1 judges if a response is received from OS debugger communication means C2 (Step S 66). If no response is received (Step S 66; No), the operation of application 60 will not be resumed but put in a waiting state. In other words, the next task of application 60 will not be executed and remain in a waiting state until there is a response from OS debugger communication means C2.

Next, the process flow on the OS debugger 80 side will be explained. The OS debugger communication means C2 receives a notice of change sent from application communication means C1 at step S 64 (Step S 81). The OS debugger communication means C2 instructs common control information reading means 83 to read out event flag EF1 of common control information SS1.

On instructions from OS debugger communication means C2, the common control information reading means 83 reads out event flag EF1 of common control information SS1 (Step S 82). The read information of event flag EF1 is conveyed from common control information reading means 83 to display processing means 84, and converted into image signals at display control section 91 and displayed on a display screen (not shown) (Step S 83).

In this connection, the image signals are so displayed on the display screen that the user visually can see that event flag EF1 is 1. Thus, the user can easily grasp process linkage between application 60 and OS (not shown) and understand that application 60 is synchronized with OS debugger 80 in processing.

After event flag EF1 is displayed, OS debugger communication means C2 sends a response to application communication means C1, directing that the stopped application 60 should be freed (restart directive) (Step S 84). As an alternative to that, the response from OS debugger communication means C2 to application communication means C1 may be served via a flag on RAM showing that event flag EF1 of common control information SS1 is displayed, or the communication function of OS may be utilized.

Next, the description will be returned to the process flow on the application 60 side. In case application communication means C1 receives a response from OS debugger communication means C2 (Step S 66; Yes), the operation of the application will be resumed (Step S 67). Then, the process returns to Step S 60 again, and the next task D after task C is executed by the application debugger, and the process from Step S 60 to Step S 67 is repeated.

As set forth above, since the operation of application 60 is suspended until the communication between application communication means C1 and OS debugger communication means C2 is over, the OS control information OS1 will not be changed by OS simulator 70 until common control information SS1 is read in by common control information reading means 83 of OS debugger 80. Through this process, the OS debugger 80 acquires all changes in OS control information OS1 without exception, and can share data without fail with application 60 while synchronizing with it though the OS debugger is in a space separated from that for application 60.

An example of system call “set_flg” has been just been described. In the case of system call “clr_flg,” too, it is possible to let the user visually know in the same way that event flag EF1 of OS control information OS1 is changed from 1 to 0.

Also, in case the execution state of a task now being executed (hereinafter “executed task”) is changed, the process shown in FIG. 4 can be applied. There will be explained, by way of example, the case of a system call “slp_flg” to switch executed task C from “execution state” to “waiting state,” and the system call “wup_flg” which is a system call “slp_tsk” issued by a task other than executed task C which changes the executed task from “waiting state” to “executable state.”

After a system call “slp_flg” is processed by system call processing means 71 (Step S 61), for example, the task execution state TS of OS control information OS1 is changed from “execution state” to “waiting state” (Step S 62). Then, the task execution state TS1 of the common file F1 is switched from “execution state” to “waiting state” (Step S 64).

After a notice of change is sent from application communication means C1 to OS debugger communication means C2 (Step S 65), application 60 will be in a waiting state (Step S 66). On the OS debugger 80 side, after OS debugger communication means C2 receives the notice of change from application communication means C1 (Step S 81), the task execution state TS1 of the common file F1 is read out and displayed on the display screen (Step S 83).

Then, OS debugger communication means C2 responds to application communication means C1 (Step S 84). In case a response is received by application communication means C1 (Step S 66; Yes), the operation of application 60 will be resumed (Step S 67).

The case of a system call “slp_tsk” has just been explained. In the case of a system call “wup_tsk,” too, it is possible to let the user visually know that the task execution state TS of OS control information OS1 is switched from “waiting state” to “executable state.”

The change in execution of one executed task has just been described. The task execution states of all the tasks of application 60 may be stored in common control information SS1 of the common file F1. This way, it is possible to arrange that the user can visually grasp the state of all the tasks.

In the description of the process flow in FIG. 4, it is so configured that each time there is a change in common control information SS1 of the common file F1, the changed common control information SS1—synchronized with a change of OS control information OS1 by OS simulator 70—is displayed on the display screen. This arrangement may be changed as necessary.

For example, it is so arranged that the history of changes of common control information SS1 is stored cyclically in common control information SS1 using a timer in advance and is displayed on the display screen, when so instructed by the user. To be concrete, it may be so configured that when the user checks a change of OS control information OS1 on the display screen, the operation panel like a keyboard is operated by the user and the history of changes stored in the common file F1 is read out on the screen. In this case, the signal inputted from the operation panel is notified to user interface 81 via interface section 92, and on instructions of main processing means 82, common control information reading means 83 reads out the history of changes from the common file F1.

For application 60 to materialize the functions of the mobile terminal, processing of events of various kinds can be thought of, including telephone call, registration of a telephone directory, Internet communication. In application 60 where a plurality of such events require to be processed continuously and real-time, it is necessary to recognize the correlation of state transition among all the tasks. In such a case, if the history of changes of common control information SS1 corresponding to all the tasks are stored in the common file F1 in advance, the user can easily check on the screen the histories of state transition among all the tasks, event flags, errors in linkage processing between application 60 and OS, whereby debugging efficiency will be improved.

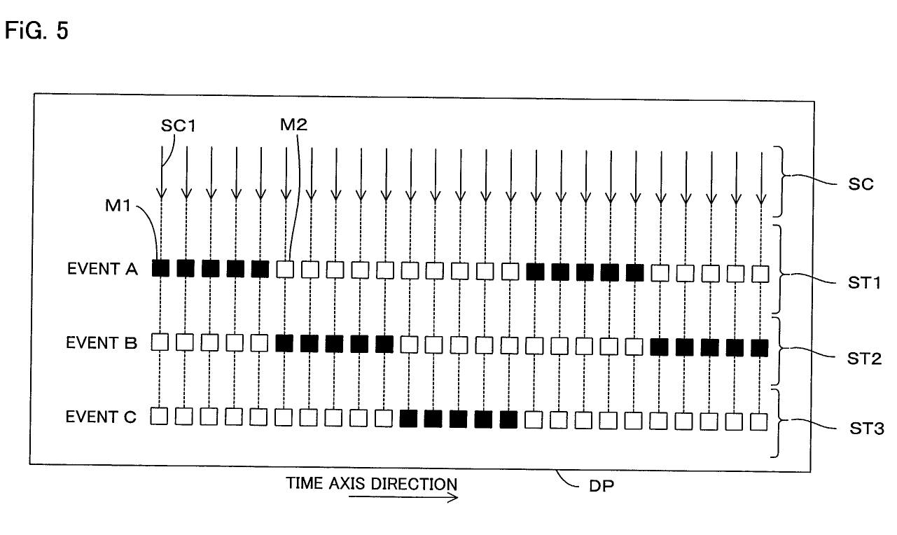

There will be explained an example where the state transition of a plurality of tasks from the common file F1 is displayed on the screen. FIG. 5 is an example of the screen on which the state transition of a plurality of tasks in the same embodiment is displayed.

In FIG. 5, DP indicates a display screen. SC indicates a group of marks indicating that communication is executed between application communication means C1 and OS debugger communication means C2. ST1 indicates a group of marks showing the state transition corresponding to event A. ST2 indicates a group of marks showing the state transition corresponding to event B.

Mark 1 in the respective task state transitions ST1, ST2, ST3 indicates that a task corresponding to the event is in “executable state.” That is, the mark indicates that according to changes in task execution state in OS control information OS1 by OS simulator 70, the task execution state in common control information SS1 of the common file F1 is changed to “executable state.” Mark M2 in the respective task state transitions ST1, ST2, ST3 indicates that a task corresponding to the event is in “waiting state.” In other words, the mark indicates that in accordance with a change in task execution state in OS control information OS1, the task execution state in common control information SS1 in the common file F1 is switched to “waiting state.”

SC1 indicates that in accordance with a change in task execution state in OS control information OS1 by OS simulator 70, the task execution state in common control information SS1 of the common file F1 is switched to “executable state,” and that communication is executed between application communication means C1 and OS debugger communication means C2.

In the example shown in FIG. 5, the task execution state transition and the history of communication between application communication means C1 and OS debugger communication means C2 are shown for every event along the time axis. For example, the first five tasks in event A are in an “executable state” and the first five tasks in event B and event C are in an “waiting state.” During that time, communication between application communication means C1 and OS debugger communication means C2 is executed without fail, and a change of OS control information OS1 on the application 60 side could be read by OS simulator 70 in a synchronized manner.

That is, the screen example as shown in FIG. 5 visually shows the history of application communication means C1 and OS debugger communication means C2 in events A, B and C and the task execution state transition of the respective events. On that screen, the user can visually and easily check the state transition of every event executed by application 60, problems in linkage with OS, etc. Thus, debugging efficiency can be improved.

Furthermore, in case data is read out cyclically by OS debugger 80 using a timer, too, the cycle in which data is read out from the common file can be synchronized without fail with the cycle in which OS control information is changed by OS simulator.

As set forth above, because the operation of application 60 is suspended until two-way communication between application communication means C1 and OS debugger communication means C2 is executed, there will be no change of OS control information OS1 by OS simulator 70 until common control information SS1 is read in by common control information reading means 83 of OS debugger 80. It ensures that OS debugger 80 can acquire all changes of OS control information OS1 without exception, and data can be shared without fail between application 60 and OS debugger 80 which is in another process space.

By displaying on the screen contents of changes of OS control information OS1 and the history of changes, in addition, it is possible to visually grasp the operation of application 60 and OS. Thus, debugging efficiency can be improved.

While there have been described preferred embodiments of the present invention, it is understood that the invention is not limited thereto and that changes and variations may be made without departing from the spirit or scope of the invention.

There have been shown examples in which the debugging supporting apparatus according to the present invention is applied to the mobile terminals such as portable phones, but it is understood that the invention is not limited thereto. For example, the present invention can be applied to debugging of applications which are executed in devices with built-in real-time OS requiring multi-task processes such as network terminal.

Furthermore, if memory areas for the respective common files are set by types of OS control information beforehand, it is possible to display the history of changes in other OS control information such as semaphore state, mail box state etc. in the same procedure.

Also, OS control information to be controlled by OS simulator may be stored in the common file so that storage means and the common file are made common to each other. To be concrete, OS control information can be shared between the application and OS debugger by OS simulator renewing OS control information on the common file. Because of this, even if the application stops, OS control information can be referred to through OS debugger.

Generally, in case OS simulator simulates real-time OS, the OS simulator has to return a response to a specific interruption within a specified time. As mentioned above, therefore, there is no possibility in practice that a storage medium with slow access is used in the storage place of OS control information. In debugging on the general-purpose OS, however, the purpose is to verify the operation and it is seldom necessary to fully simulate real-time processability. Therefore, in simulating OS which does not require to be done real-time, it can be said that there is no problem if the storage destination of the OS control information is made a common file.

Also, it may be so configured that the program of the present invention is offered in a removable form for the general-purpose computer by storing the program on such storage media as CD-ROM, FD, and DVD. In this form, the program of the present invention can be readily distributed and sold as software independently of the device. The present invention can be carried out easily on hardware by applying this software using such hardware as general-purpose computer and general-purpose game apparatus.

In addition, the program and data embodying the present invention may be in the form of receiving data from other equipment connected via telecommunication line or the like and recording on memory. Also, it may be so formed that the above-mentioned program or data is recorded on memory on the other equipment side connected via telecommunication line so that this program or data is used via telecommunication line etc.

According to the present invention, since, synchronized with a change of OS control, the change of OS control information is reflected in the common file information of the common file, OS control information can be referred to without difficulty even if the application stops. That makes debugging efficient.

It is also noted that OS control information can be changed from the OS debugger, and therefore even if OS control information is a false value, it is possible to continue verification of the operation of application and also to create a situation in which an interrupt occurs without modifying the program of the application.

Furthermore, because the operation of application stops until the communication between the application and the OS debugger is over, the OS debugger can acquire changes of OS control information without exception.

What is claimed is:

1. A debugging supporting apparatus provided with:
an application to which is linked an OS simulator to simulate a specific OS on a general-purpose OS,
storage means for storing OS control information controlled by said application under the control of said OS simulator, and
an OS debugger to refer to or change said OS control information, said apparatus comprising:
a common file shared between said application and said OS debugger and storing common control information including the same data as the item constituting said OS control information,
writing means for writing on said common file specific item of said OS control information stored in said storage means as common control information, and
reading means for reading out said common control information stored in said common file.

2. The debugging supporting apparatus as defined in claim 1,
wherein said writing means is provided on the side of said application and writes on said common file changes in said specific item as common control information in compliance with instructions by said OS simulator and
wherein said reading means is provided on the side of said OS debugger and reads out the common control information stored in said common file in compliance with instructions by said OS debugger.

3. The debugging supporting apparatus as defined in claim 2 which is further provided with:
application communication means, in case said writing means writes on said common file changes in said specific item as common control information, sends directions to read out said common control information to said OS debugger from said application and
OS debugger communication means for, on receiving said directions, issuing to said reading means instructions to read out said common control information.

4. The debugging supporting apparatus as defined in claim 3
wherein said application communication means sends to said OS debugger directions to reads out said common control information and, at the same time, stops execution of said application, and
wherein said OS debugger communication means sends back to said application a direction to free said stopped application after said reading means reads out said common control information.

5. The debugging supporting apparatus as defined in claim 2 wherein said reading means reads out said common control information from said common file at any time.

6. The debugging supporting apparatus as defined in claim 2 wherein said reading means reads out common control information from said common file in a specific cycle.

7. The debugging supporting apparatus as defined in claim 1 wherein said specific OS is a real-time OS.

8. The debugging supporting apparatus as defined in claim 1 wherein said application control is control of task execution by said application.

9. The debugging supporting apparatus as defined in claim 1 wherein the common control information to be stored in said common file is concurrently said OS control information.

10. A debugging supporting apparatus provided with:
an application to which is linked an OS simulator to simulate a specific OS on a general-purpose OS,
storage means for storing OS control information controlled by said application under the control of said OS simulator, and
an OS debugger to refer to or change said OS control information, said apparatus comprising:
a common file shared between said application and said OS debugger and storing common control information including debugging instructions to change OS control information stored by said storage means,
debugging instructions writing means for writing said debugging instructions in said common file as common control information,
debugging instructions reading means for reading out debugging instructions from common control information stored in said common file, and
OS control information changing means for changing specific item forming said OS control information in accordance with debugging instructions read out by said debugging instructions reading means.

11. The debugging supporting apparatus as defined in claim 10
wherein said debugging instructions writing means is provided on the side of said OS debugger and writes in said common file said debugging instructions as said common control information in compliance with a request from said OS debugger, and
wherein said debugging instructions reading means is provided on the side of said application and reads out debugging instructions.

12. The debugging supporting apparatus as defined in claim 11 wherein said debugging instructions reading means reads out debugging instructions from said common file at any time.

13. The debugging supporting apparatus as defined in claim 11 wherein said debugging instructions reading means reads out debugging instructions from said common file in a specific cycle.

14. The debugging supporting apparatus as defined in claim 10 wherein said specific OS is a real-time OS.

15. The debugging supporting apparatus as defined in claim 10 wherein said application control is control of task execution by said application.

16. A debugging supporting method using a computer provided with:
an application to which is linked an OS simulator to simulate a specific OS on a general-purpose OS,
storage means for storing OS control information to control said application under the control of said OS simulator, and
an OS debugger to refer to or change said OS control information, said method comprising the steps of:
writing specific item forming OS control information stored in said storage means on a common file shared between said application and said OS debugger and
reading out the common file where said specific item is written.

17. The debugging supporting method as defined in claim 16, further comprising:
first communication step of sending directions to read out said common file to OS debugger from said application in case said writing means writes on said common file a change in said item, and
second communication step of reading out said common file on receiving said directions.

18. The debugging supporting method as defined in claim 17,
wherein said first communication step sends to said OS debugger directions to read out said common file and stops execution of said application, and
wherein said second step sends back said application directions to said application to free said stopped application after said common file is read out.

19. The debugging supporting method as defined in claim 16, wherein said common file is concurrently said OS control information.

20. A debugging supporting method using a computer provided with:
an application to which is linked an OS simulator to simulate a specific OS on a general-purpose OS,
storage means for storing OS control information to control said application under the control of said OS simulator, and
an OS debugger to refer to or change said OS control information, said method comprising the steps of:
writing debugging instructions to change OS control information on
a common file shared between said application and said OS debugger,
reading out said debugging instructions from said common file, and
changing specific item forming said OS control information on the basis of said read debugging instructions.

21. A recording medium readable by computer with programs recorded thereon, said computer provided with:
an application to which is linked an OS simulator to simulate specific OS on general-purpose OS,
storage means for storing OS control information to control said application under the control of said OS simulator, and
an OS debugger to refer to or change said OS control information,
said programs being for the computer to execute the steps of:
writing specific item forming OS control information stored in storage means on a common file shared between said application and said OS debugger and
reading out said common file with specific item written therein.

22. The recording medium readable by computer as defined in claim 21, wherein programs are further recorded for the computer to execute:
first step of sending directions to read said common file to said OS debugger from said application when said writing step writes changes of said specific item on said common file and
second step of reading out said common file on receiving said directions.

23. The recording medium readable by computer as defined in claim 22, wherein said first step sends to said OS debugger directions to read out said common file and stops the execution of said application and
wherein said second step sends back to said application directions to free said stopped application after said common file is read out.

24. The recording medium readable by computer as defined in claim 21, wherein said common file is concurrently said OS control information.

25. A recording medium readable by computer with programs recorded thereon, said computer provided with:
said application to which is linked an OS simulator to simulate specific OS on general-purpose OS,
storage means for storing OS control information to control said application under the control of said OS simulator, and
said OS debugger to refer to or change said OS control information,
said programs being for the computer to execute the steps of:
writing debugging instructions to change OS control information on a common file shared between said application and said OS debugger,
reading out said debugging instructions from said common file and
changing specific item forming OS control information on the basis of said read debugging instructions.
